(19) United States
(12) Patent Application Publication
(10) Pub. No.: US 2009/0153536 A1
(43) Pub. Date: Jun. 18, 2009

(54) RECEIVING MODULE AND SIGNAL TRANSMITTING APPARATUS USING THE SAME

(75) Inventors: Tomo Baba, Kanagawa (JP); Osamu Takanashi, Kanagawa (JP); Hidenori Yamada, Kanagawa (JP)

Correspondence Address: FILDES & OUTLAND, P.C., 20916 MACK AVENUE, SUITE 2, GROSSE POINTE WOODS, MI, 48236, US

(73) Assignee: FUJI XEROX CO., LTD., Tokyo (JP)

(21) Appl. No.: 12/137,908

(22) Filed: Jun. 12, 2008

(30) Foreign Application Priority Data
Jul. 5, 2007 (JP) 2007-177132

(51) Int. Cl. G09G 5/00

(52) U.S. Cl. 345/211

(57) ABSTRACT

A receiving module includes a receiving unit and a power supply substrate. The receiving unit includes a connector that receives an image signal and a control signal from a signal transmitting medium. And the power supply substrate is provided in an image display device and supplies a power to the receiving unit upon receipt of a supply of the power from the image display device and outputs the image signal and the control signal from the receiving unit to the image display device.

### CROSS-REFERENCE TO RELATED APPLICATIONS

This application is based on and claims priority under 35 USC 119 from Japanese Patent Application No. 2007-177132 filed Jul. 5, 2007.

### BACKGROUND

1. Technical Field

The present invention relates to a receiving module and a signal transmitting apparatus using the receiving module.

2. Related Art

In the case in which an image signal is transmitted from a host computer to an image display device such as a liquid crystal display (LCD) or a plasma display in response to a digital image signal, for example, a DVI (Digital Visual Interface) signal, the DVI signal is converted into a light signal to be transmitted so that it is possible to carry out a long distance transmission without a transmission loss.

For example, a transmission enable distance of a DVI image signal through a metal cable (an electric cable) is approximately 5 m, while a long distance transmission of 1000 m or more can be carried out when the DVI image signal is transmitted as a light signal through an optical fiber.

In a DVI, (DC+5V) is output to a control signal. In the TMDS (Transmission Minimized Differential Signaling) standards formulated by DDWG (Digital Display Working Group), an upper limit of a capacity of +5V is 50 mA. On the other hand, in transmitting and receiving modules for converting a light signal and an electric signal, a current of several hundreds mA is required. For this reason, it is impossible to drive the transmitting and receiving modules by using a DVI power line.

### SUMMARY

According to an aspect of the invention, a receiving module includes a receiving unit and a power supply substrate. The receiving unit includes a connector that receives an image signal and a control signal from a signal transmitting medium. And the power supply substrate is provided in an image display device and supplies a power to the receiving unit upon receipt of a supply of the power from the image display device and outputs the image signal and the control signal from the receiving unit to the image display device.

### BRIEF DESCRIPTION OF THE DRAWINGS

Exemplary embodiment (s) of the present invention will be described in detail based on the following figures, wherein:

FIG. 1 is a view showing a signal transmitting apparatus according to a first exemplary embodiment of the invention;

FIG. 2 is an exploded perspective view showing a receiving module;

FIG. 3A is a perspective view showing an optical DVI receiving unit of the receiving module, seen in a direction of a front surface

FIG. 3B is a perspective view showing an optical DVI receiving unit of the receiving module, seen in a direction of a rear surface;

FIG. 4 is a view showing a signal transmitting apparatus according to a second exemplary embodiment of the invention;

FIG. 5 is a view showing a receiving module in the signal transmitting apparatus of FIG. 4;

FIG. 6 is a view showing a signal transmitting apparatus according to a third exemplary embodiment of the invention; and

FIG. 7 is a view showing a signal transmitting apparatus according to a fourth exemplary embodiment of the invention.

### DETAILED DESCRIPTION

### First Exemplary Embodiment

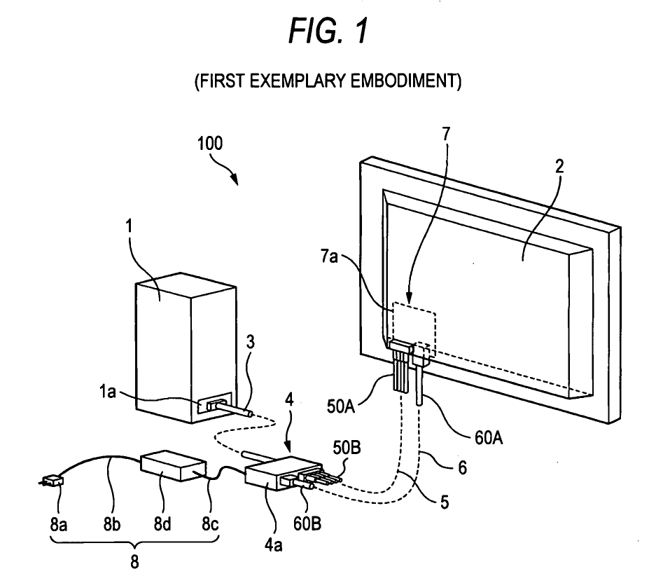

FIG. 1 is a view showing a signal transmitting apparatus according to a first exemplary embodiment of the invention. FIG. 1 illustrates back faces of a host computer and an image display device.

(Structure of Signal Transmitting Apparatus)

A signal transmitting apparatus 100 includes a host computer 1, an image display device 2 for displaying an image and outputting a voice based on image and voice data transferred from the host computer 1, a transmitting module 4 connected to the host computer 1 through a DVI cable 3, a receiving module 7 connected to the transmitting module 4 through an optical fiber 5 and an electric cable 6 which serve as signal transmitting media and attached to a back face side of the image display device 2, and an AC adaptor 8 for supplying a power to the transmitting module 4.

For example, a personal computer put on the market may be used for the host computer 1, and the host computer 1 has a back face provided with a PCI slot (Peripheral Component Interconnect bus slot) 1a to be an expansion slot, and a back panel (not shown) for keyboard and mouse sockets, an LAN jack, an audio port connector and a USB connector. Moreover, a front surface is provided with a DVD/CD drive, a floppy (registered trademark) disk drive, a power switch, a reset switch and an LED for displaying an operating state. Moreover, the host computer 1 has a function for outputting an image signal through a DVI.

The host computer 1 is disposed in a station, a department store, or a control office for an exhibition hall, for example. And the image display device 2 has a comparatively large screen size and is disposed in a place at a long distance from the host computer 1, for example, a wall surface or a ceiling of a platform of a station, a resting-place, an information office or an exhibition corner.

The image display device 2 has a processing circuit connected to the receiving module 7, and a DVI compatible LCD (liquid crystal display) is used for a display unit, for example. Furthermore, the image display device 2 includes a display control circuit for driving the LCD, a voice amplifying circuit, a speaker and a power circuit (any of which is not shown).

The transmitting module 4 has a body 4a including a substrate on which (i) an electric-optic converting device that converts a DVI signal sent from the host computer 1 into a light signal and (ii) a processing circuit and a stabilizing power circuit are mounted. And the DVI cable 3, the optical fiber 5 and the electric cable 6 are connected to connectors (not shown) provided on a side surface of the body 4a.

The optical fiber 5 is a multimode fiber, and has optical connectors 50A and 50B attached to both ends. In the exemplary embodiment, the optical fiber 5 is constituted by four cores and can transmit 4-bit light signals at the same time.

The electric cable 6 is a signal wire of “category 5” or “category 6” to be used in an LAN, and has electric connectors 60A and 60B attached to both ends thereof.

The receiving module 7 includes a photoelectrical converting device that converting a DVI signal based on a light signal sent from the optical fiber 5 into a DVI signal based on an electric signal, and a processing circuit. A power of the receiving module 7 is supplied from a power circuit of the image display device 2.

The AC adaptor 8 has a body 8d including a power transformer and a rectifying circuit in the body 8d. A cord 8b to which a plug 8a to be inserted into an AC 100V socket is attached and a cord 8c connected to the transmitting module 4 are connected to the body 8d.

(Structure of Receiving Module)

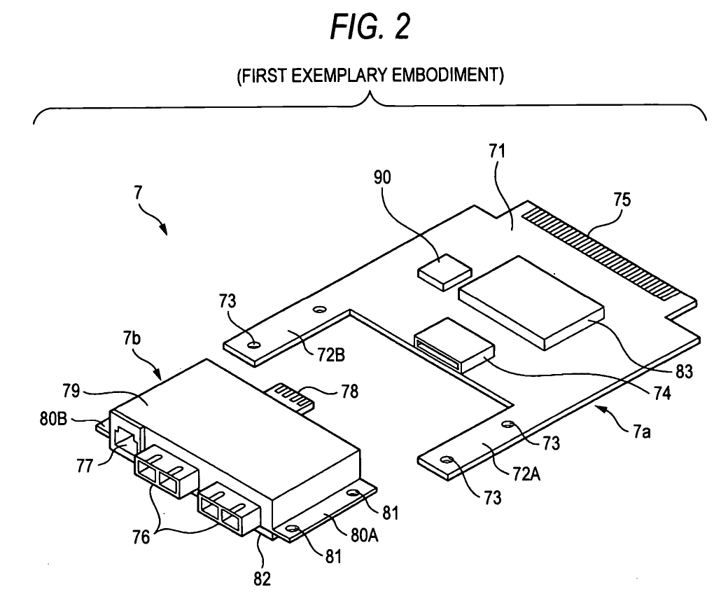

FIG. 2 is an exploded perspective view showing a receiving module.

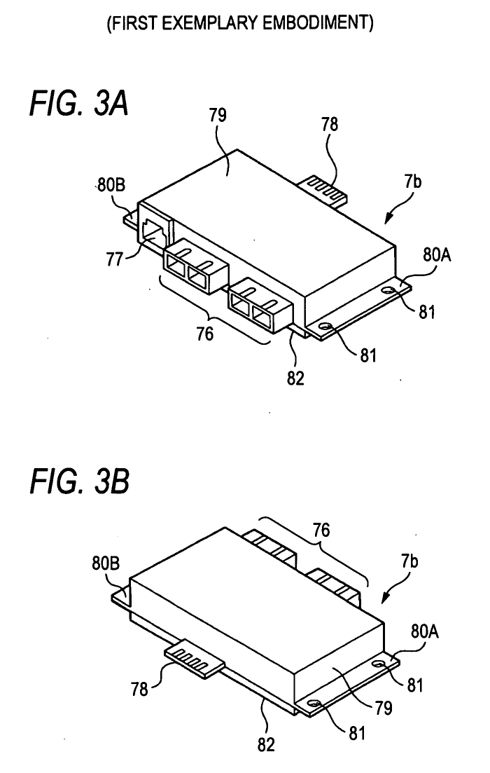

FIG. 3 shows an optical DVI receiving unit of the receiving module, and FIG. 3A is a perspective view seen in a direction of a front surface and FIG. 3B is a perspective view seen in a direction of a rear surface.

As shown in FIG. 2, the receiving module 7 includes a power supply substrate 7a accommodated in the image display device 2, and an optical DVI receiving unit 7b serving as a receiving unit which is connected to the power supply substrate 7a and receives an image signal from the transmitting module 4.

The power supply substrate 7a includes a printed wiring board 71 having a side on the optical DVI receiving unit 7b side taking a U shape, four screw holes 73 provided on protruded pieces 72A and 72B of a U-shaped portion in order to screw and fix the optical DVI receiving unit 7b, an electric connector 74 provided on the printed wiring board 71 along an inside of the U-shaped portion and connected to the optical DVI receiving unit 7b, a connecting terminal 75 provided on a side at an opposite side to a side on the optical DVI receiving unit 7b side and connected to a circuit in the image display device 2, an IC 83 mounted on the printed wiring board 71 and serving to output a video signal to the connecting terminal 75 upon receipt of a TMDS signal, and an IC 90 for a power supply which serves to generate a DC voltage such as 5V or 3.3V which is required for the IC 83 and a photoelectrical converting device in the optical DVI receiving unit 7b upon receipt of a predetermined power supply from a power circuit of the image display device 2. The electric connector 74 and the connecting terminal 75 have a part connected directly through a wiring pattern which is not shown, and the others are connected through the IC 83. Moreover, such as a filter to be inserted in a signal system if necessary is mounted on the printed wiring board 71.

As shown in FIG. 3, the optical DVI receiving unit 7b has a front surface provided with (i) plural optical connectors 76 to which the optical connector 50A on the optical fiber 5 side is connected and (ii) an electric connector 77 to which the electric connector 60A of the electric cable 6 is connected. And the optical DVI receiving unit 7b has a rear surface provided with an electric connector 78 to be connected to the electric connector 74. And the connectors 76 to 78 are mounted on a substrate 82. Furthermore, a photoelectrical converting device, an amplifier and a processing circuit (any of them is not shown) which are connected to the optical connector 76 are mounted on the substrate 82.

In addition, the optical DVI receiving unit 7b is provided with a metallic shield 79 to cover the substrate 82, and attaching pieces 80A and 80B are provided on both sides thereof. The attaching pieces 80A and 80B are provided with four screw holes 81 corresponding to the four screw holes 73. The shield 79 is provided to prevent an external noise from influencing such as the photoelectrical converting device and the amplifier.

(Assembly of Receiving Module)

First of all, the printed wiring board 71 is provided with the protruded pieces 72A and 72B and the connecting terminal 75, and furthermore, there is prepared the power supply substrate 7a provide with the printing writing board 71 and the electric connector 74, the IC 83 and the IC 90 for a power supply which are mounted thereon.

Next, the attaching pieces 80A and 80B of the power supply substrate 7a are positioned on the protruded pieces 72A and 72B of the optical DVI receiving unit 7b. In that state, the optical DVI receiving unit 7b is moved in a direction toward the electric connector 74 to insert the electric connector 78 into the electric connector 74. Moreover, the four screw holes 73 are matched with the four screw holes 81.

Next, a screw which is not shown is inserted into the screw holes 73 and 81 which are superposed with each other, and they are fastened with a nut which is not shown.

(Operation of Signal Transmitting Apparatus)

Next, an operation of the signal transmitting apparatus 100 will be described with reference to FIGS. 1 and 2. As shown in FIG. 1, the transmitting module 4 is connected to the host computer 1 through the DVI cable 3, and the transmitting module 4 and the receiving module 7 of the image display device 2 are connected to each other through the optical fiber 5 and the electric cable 6. Moreover, the plug 8a of the AC adaptor 8 is inserted into a 100V socket, and the cord 8c is connected to a power socket of the transmitting module 4. In addition, the plugs of power cords of the host computer 1 and the image display device 2 are inserted into the 100V socket.

Next, the host computer 1, the image display device 2 and the transmitting module 4 are turned ON. When the image display device 2 is turned ON, a power of +6V is supplied to the IC 90 for a power supply in the power supply substrate 7a through the connecting terminal 75 and the IC 90 for a power supply generates a stabilized DC voltage of +5V or +3.3V from 6V.+5V is supplied as an output voltage of the IC 90 for a power supply to the IC 83, and +3.3V is supplied to the photoelectrical converting device and the amplifier of the optical DVI receiving unit 7b.

By a manipulation of an operator, the host computer 1 generates a DVI signal (TMDS data 0± to TMDS data 2±, a clock signal TMDS clok±) for image and voice data to be displayed on the image display device 2, and transmits the DVI signal to the transmitting module 4 through the DVI cable 3. The transmitting module 4 outputs, to the optical fiber 5, a video signal to be a signal having a high frequency of several hundreds MHz to several GHz, that is, Red, Green, Blue and Clock signals and outputs, to the electric cable 6, a control signal having a low frequency of several hundreds kHz, that is, a DDC (Display Data Channel) signal and an HPD (Hot Plug Detect) signal for recognizing the connection of the image display device 2. The HPD signal is a signal for confirming the connection of the host computer 1 to the image display device 2.

The video signal is transmitted to the receiving module 7 through the optical fiber 5 and is subjected to photoelectrical conversion by the optical DVI receiving unit 7b of the receiving module 7. Furthermore, the R, G and B signals are converted into serial signals through the IC 83.

Moreover, the control signal is transmitted to the receiving module 7 through the electric cable 6. Both the control signal and the image signal converted by the IC 83 are output to the electric connector 78, and furthermore, are output to the connecting terminal 75 through the electric connector 74 of the power supply substrate 7a.

The video signal and the control signal which are transmitted from the connecting terminal 75 are sent to the signal processing circuit in the image display device 2, and furthermore, a display control circuit and an LCD driving circuit are operated so that an image is displayed on the LCD.

### Second Exemplary Embodiment

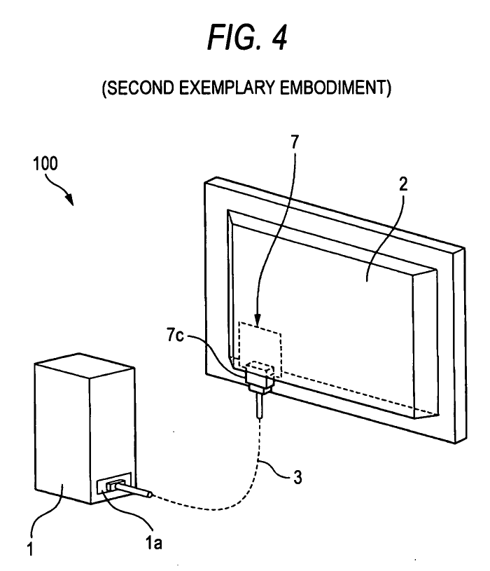

FIG. 4 is a view showing a signal transmitting apparatus according to a second exemplary embodiment of the invention. FIG. 4 shows back faces of a host computer and an image display device.

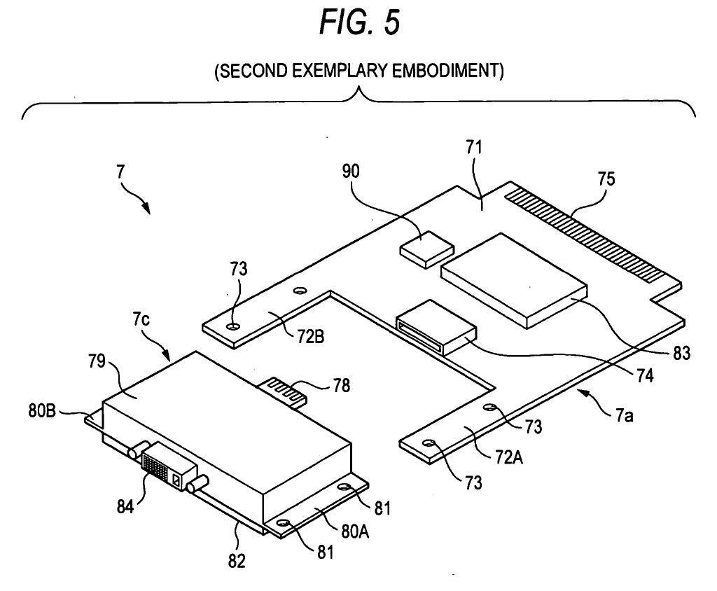

FIG. 5 is a view showing a receiving module in the signal transmitting apparatus of FIG. 4.

In the exemplary embodiment, an electric DVI receiving unit 7c corresponding to an electric signal is used in place of the optical DVI receiving unit 7b, and furthermore, the transmitting module 4 and the AC adaptor 8 are removed and the electric DVI receiving unit 7c and the host computer 1 are directly connected to each other through the DVI cable 3, and the other structures are the same as those in the first exemplary embodiment.

As shown in FIG. 5, the electric DVI receiving unit 7c is constituted by mounting a DVI connector 84 in a front part on a substrate 82, and an electric connector 78 is connected to the DVI connector 84 through a wiring pattern which is not shown. Accordingly, the electric DVI receiving unit 7c mounts neither a photoelectrical converting device nor a processing circuit. Moreover, an optical transmission is not carried out. For this reason, the transmitting module 4 shown in FIG. 1 is not required.

A structure of a power supply substrate 7a is the same as that in the first exemplary embodiment. Although the voltage of 3.3V is applied to a power terminal of an electric connector 74, therefore, the electric DVI receiving unit 7c side is not connected to the electric connector 74.

Since the DVI cable 3 is an electric cable, moreover, it is easily influenced by an external noise. Accordingly, a signal transmitting apparatus 100 using the electric DVI receiving unit 7c does not require an optical transmission and may be used in the case in which a distance between the host computer 1 and an image display device 2 is short (for example, 5 m or less).

### Third Exemplary Embodiment

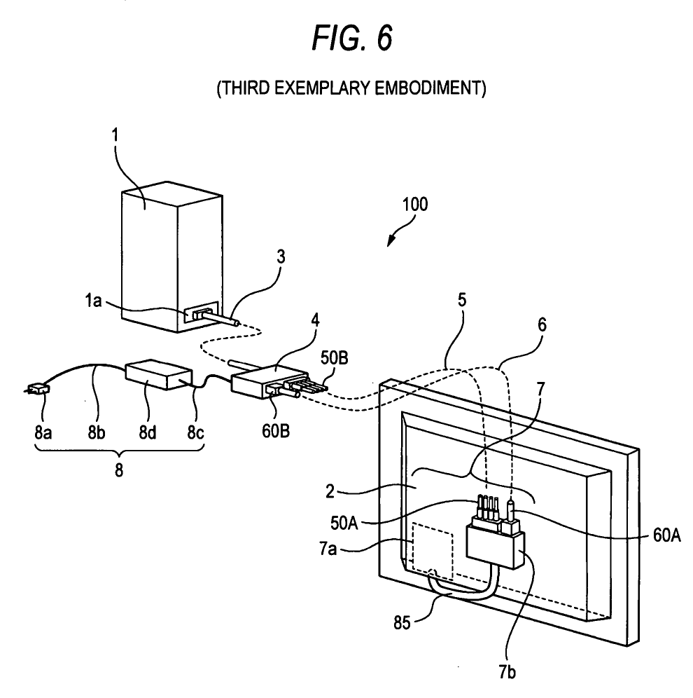

FIG. 6 is a view showing a signal transmitting apparatus according to a third exemplary embodiment of the invention.

In the exemplary embodiment, the power supply substrate 7a and the optical DVI receiving unit 7b are separated from each other and both of them are connected to each other through an electric wire 85, and furthermore, the optical DVI receiving unit 7b is attached to the back face of the image display device 2 in such a manner that the optical connector 50A and the electric connector 60A are turned upward in the first exemplary embodiment, and the other structures are the same as those in the first exemplary embodiment.

A power is supplied from the power supply substrate 7a to the optical DVI receiving unit 7b through the electric wire 85. Moreover, a DVI signal obtained by photoelectrical converting, through the optical DVI receiving unit 7b, a light signal sent from an optical fiber 5 is transmitted to the image display device 2 through the electric wire 85.

Although the power supply substrate 7a has the same function as that in the first exemplary embodiment, the optical DVI receiving unit 7b is not directly attached thereto. Therefore, it is also possible to employ a structure in which the protruded pieces 72A and 72B shown in FIG. 2 are not provided.

The optical fiber 5 and an electric cable 6 which are provided in the vicinity of the optical connector 50A and the electric connector 60A are set to be pulled out from above as shown in FIG. 6 and are wired in such a manner that people passing below the image display device 2 can see neither the optical fiber 5 nor the electric cable 6. The directions of the optical connector 50A and the electric connector 60A are not restricted to the upper side but may be optional directions, for example, an obliquely upper direction or a transverse direction.

### Fourth Exemplary Embodiment

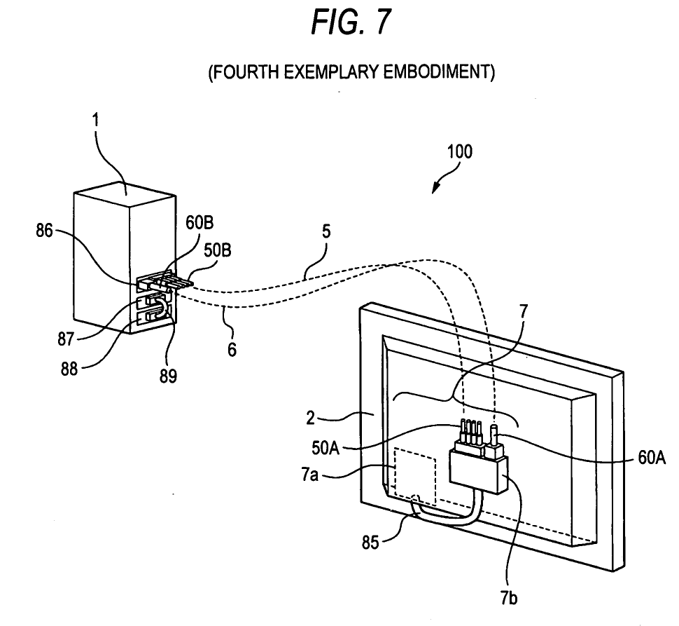

FIG. 7 is a view showing a signal transmitting apparatus according to a fourth exemplary embodiment of the invention.

(Structure of Signal Transmitting Apparatus)

In the exemplary embodiment, the transmitting module 4 and the AC adaptor 8 are removed, an electric-optic converting board 86, a power supply board 87 and a graphic board 88 having an output terminal for a DVI signal are attached to an expansion slot of the host computer 1, and the electric-optic converting board 86 and the optical DVI receiving unit 7b are connected to each other through the optical fiber 5 and the electric cable 6 in the third exemplary embodiment shown in FIG. 6, and the other structures are the same as those in the third exemplary embodiment.

(Operation of Signal Transmitting Apparatus)

When the DVI signal is output from the graphic board 88 of the host computer 1, it is transmitted from the graphic board 88 to the power supply board 87 through an electric cable 89. The power supply board 87 is caused to output the DVI signal to the electric-optic converting board 86, and the DVI signal is converted into a video signal to be an optical digital signal through the electric-optic converting board 86.

A light signal is transmitted from the electric-optic converting board 86 to the optical DVI receiving unit 7b of a receiving module 7 through an optical connector 50B, an optical fiber 5 and an optical connector 50A. Moreover, a control signal of the DVI signal is transmitted to an image display device 2 through an electric connector 60B, an electric cable 6 and an electric connector 60A. The optical DVI receiving unit 7b photoelectrically converts the DVI signal, and the DVI signal thus converted photoelectrically and the control signal received through the electric cable 6 are transmitted to a signal processing circuit in the image display device 2, and furthermore, a display control circuit and an LCD driving circuit are operated so that an image is displayed on an LCD of the image display device 2.

### OTHER EMBODIMENTS

The invention is not restricted to each of the exemplary embodiments but can be variously changed without departing from the scope thereof. For example, it is possible to optionally combine the components in the respective exemplary embodiments.

Although the digital image signal is set to be the DVI signal in the exemplary embodiments, moreover, the invention can also be applied to HDMI (High Definition Multimedia Interface) in which a transmission/receipt is carried out through the same TMDS signal. Furthermore, it is apparent that the invention can also be applied to an image signal transmission through the same digital signal.

While the image display device 2 is set to have the structure using the LCD, moreover, it is also possible to use a display through another operation principle, for example, a plasma display or a CRT.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A receiving module comprising:
a receiving unit that includes a connector which receives an image signal and a control signal from a signal transmitting medium; and
a power supply substrate that is provided in an image display device, supplies a power to the receiving unit upon receipt of a supply of the power from the image display device and outputs the image signal and the control signal obtained from the receiving unit to the image display device.

2. The receiving module according to claim 1,
wherein the connector includes an optical connector which receives the image signal and an electric connector which receives the control signal.

3. The receiving module according to claim 1,
wherein the connector is a connector for transmitting a Digital Visual Interface signal.

4. The receiving module according to claim 1,
wherein the receiving unit is removable from the power supply substrate.

5. A signal transmitting apparatus comprising:
the receiving module according to claim 1;
an image display device that includes the receiving module on a back face;
a host computer that provides the image signal and the control signal to the image display device; and
wherein the signal transmitting medium connects the host computer to the receiving module.

6. The signal transmitting apparatus according to claim 5,
wherein the receiving module is disposed in such a manner that the signal transmitting medium is connected to the receiving module in an optional direction to the image display device.

7. The signal transmitting apparatus according to claim 5,
wherein the receiving module has the power supply substrate and the receiving unit separated from each other, and the power supply substrate and the receiving unit are connected to each other through an electric wire.

8. The signal transmitting apparatus according to claim 5,
wherein the host computer outputs one of a Digital Visual Interface signal or an High Definition Multimedia Interface signal as the image signal.

9. The signal transmitting apparatus according to claim 5,
wherein the host computer includes:
an electric-optic converting board that carries out an electric-optic conversion over the image signal and outputs the image signal subjected to the electric-optic conversion; and
a power supply board that supplies a power to the electric-optic converting board which are mounted on an expansion slot.

10. The signal transmitting apparatus according to claim 5,
wherein the signal transmitting medium includes an optical fiber for transmitting the image signal and an electric cable for transmitting the control signal.

11. The signal transmitting apparatus according to claim 5,
wherein the signal transmitting medium includes an electric cable for transmitting the image signal and the control signal.
